(19) United States
(12) Patent Application Publication
(10) Pub. No.: US 2006/0283187 A1
(43) Pub. Date: Dec. 21, 2006

(54) Combustion unit for turbocharger

(76) Inventor: Roland Broadbent, Oxfordshire (GB)

Correspondence Address: NIXON & VANDERHYE, PC, 901 NORTH GLEBE ROAD, 11TH FLOOR, ARLINGTON, VA, 22203, US

(21) Appl. No.: 10/552,505

(22) PCT Filed: Apr. 6, 2004
(86) PCT No.: PCT/GB04/01494

§ 371 Date: Jun. 23, 2006

(51) Int. Cl. F02B 33/44; F02D 23/00; F01N 3/00

(52) U.S. Cl. 60/600; 60/605.1; 60/282

(57) ABSTRACT

A combustion unit (15) is primarily intended to feed a turbocharger (18) to generate a compressed air supply to an internal combustion engine (10). The unit (15) is supplied with exhaust gases from the engine and these gases are mixed with air in the unit combust material in the exhaust gases and give and enhanced supply to the turbocharger. The combustion unit is generally cylindrical and air is added to the exhaust gases at the inlet (13) to promote combustion and the combustion gases pass at high speed through an annuler space towards an outlet (17) leading to the turbocharger (18).

This invention relates to a combustion unit for turbochargers, in particular a turbocharger for an internal combustion engine, an internal combustion engine incorporating such a unit, and to a method of operating an internal combustion engine.

Turbocharging units have often been used to boost the air flow into internal combustion engines to improve performance. Such units have often suffered an inability to improve performance at low speeds and during the transition between light and full throttle settings of the engine.

It is known from U.S. Pat. No. 3,849,988 (Etat Francais), U.S. Pat. No. 3,736,752 (Etat Francais), U.S. Pat. No. 4,026,115 (Etat Franqais), U.S. Pat. No. 4,009,574 (Etat Franqais) and GB 537483 (Napier) to provide a combustion chamber which has a separate supply of fuel.

An object of the invention is to provide an improved turbocharger unit which is capable of reducing the so called turbo lag of existing units, to improve the quality of the exhaust gas and the overall engine power output.

According to one aspect, the invention provides a combustion unit for an internal combustion engine, the unit comprising a combustion chamber having an inlet for admitting exhaust gases from the internal combustion engine, an air inlet for admitting air into the chamber, and an outlet in communication with a turbocharger having an impeller, whereby to cause gases from the chamber to drive the impeller, operation of 25 the impeller being arranged to drive a compressor for generating a flow of air through the internal combustion engine; the chamber being arranged to cause combustion within the chamber of combustible products in the engine exhaust gas, wherein the chamber is generally of circular cross section and is arranged to have an exhaust gas inlet region which increases in cross-section in the downstream direction and into 30 which air is introduced, a central region downstream of the inlet region in which an annular air flow is induced, and an outlet region from which the gases of combustion are discharged from the chamber outlet to drive the impeller. preferably, the chamber is arranged to have an exhaust gas inlet region which increases in cross section in the downstream direction, a central obstruction member downstream of the inlet region to induce flow into an annular region, a central elongate member downstream of the central member and extending generally in the direction of flow of gases through the chamber and having air outlet means for introducing air into the chamber.

The unit may comprise a plurality of peripheral air outlet means whereby air is discharged at the outer periphery of the chamber.

The combustion chamber may be formed with an outer air chamber from which the air is arranged to pass into the combustion chamber from a plurality of openings.

Preferably, the central member extends along the combustion chamber from the exhaust gas inlet region towards the outlet end of the chamber and air is discharged from said central member into a combustion space in the combustion chamber, the space extending generally annularly around the elongate member.

The combustion chamber may be generally circular in internal cross-section and defines a generally annular region downstream from the exhaust gas inlet in which combustion takes place, air being introduced into the annular region from radially inner and outer locations, and air may be introduced through the walls of the combustion chamber in the region of the exhaust inlet and in the region of the exhaust gas outlet.

Usually the flow of air into the combustion chamber is derived from the same source as the air flow to the engine.

The invention also provides an internal combustion engine having an air inlet for introducing compressed combustion air into the engine, an exhaust gas outlet from the engine, a compressor for generating said compressed air flow to the engine, a compressor drive for driving the compressor, and a combustion unit providing a flow of gas for operating the compressor drive, the combustion unit having an exhaust gas inlet communicating with the exhaust gas outlet of the engine, and air inlet means for admitting air to the unit from the compressor, whereby the exhaust gas, having combustible material therein, and the air are caused to mix and combust within the unit, a gas outlet from the unit communicating with the compressor drive whereby the flow of gases from the gas outlet is arranged to drive the compressor.

Preferably, the engine comprises duct means for directing a flow of air from the compressor to the air inlet means of the combustion chamber and flow control means for controlling the rate of flow of said air to the chamber.

In another aspect of the invention there is provided a method of operating an internal combustion engine having a turbocharger, wherein the flow of compressed air from the turbocharger is directed into the engine, fuel is directed into the engine, exhaust gases from operating the engine are directed into a combustion unit in which combustion of combustible products in the exhaust gases is induced, and such combustion generates a flow of gas which is directed to the turbo charger which has an impeller and a compressor, the turbo charger generating a flow of pressurised air of which part is directed to the engine and part to the turbocharger.

Preferably, the fuel supply to the engine is controlled so that more fuel reaches the engine than is required to run the engine, whereby to increase the combustible material in the exhaust from the engine and up to 8% more fuel is supplied to the engine.

In addition, fuel may be introduced into the exhaust gases supplied to the combustion in the combustion unit.

Further features of the invention will appear from the following description of an embodiment of the invention given by way of example only and with reference to the drawings, in which:

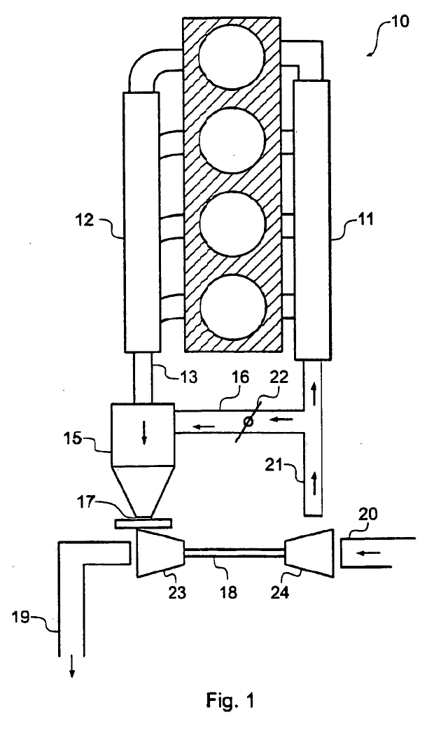

FIG. 1 is a schematic drawing of an internal combustion engine layout incorporating a turbocharger unit, and

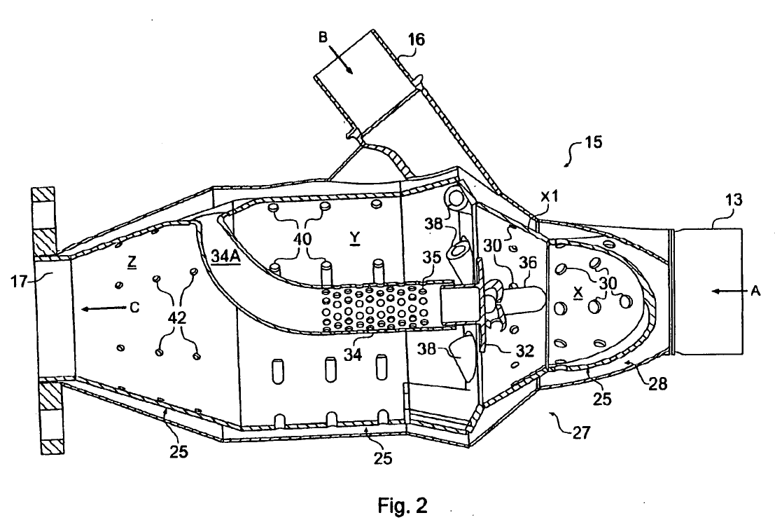

FIG. 2 is a longitudinal section through a combustion chamber of the layout to FIG. 1.

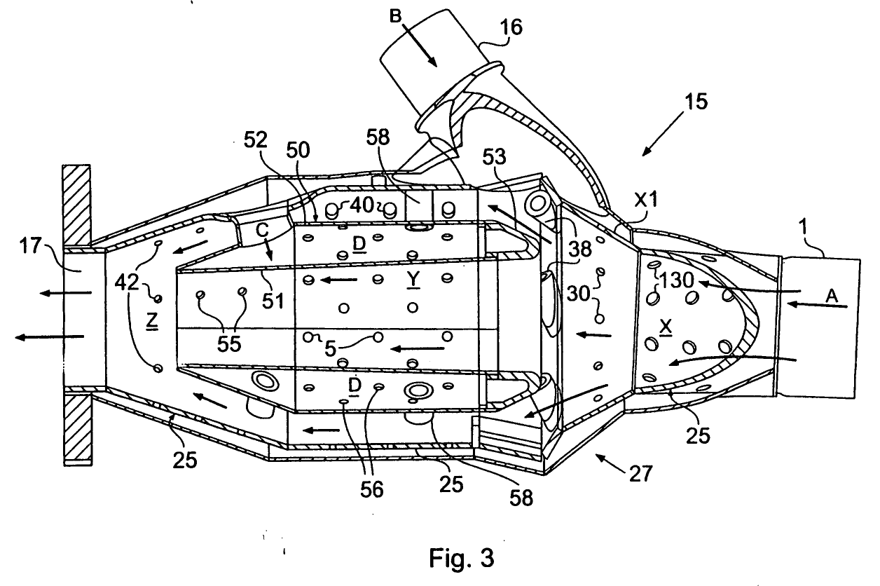

FIG. 3 is a longitudinal section corresponding to that of FIG. 2 of an alternative form of chamber,

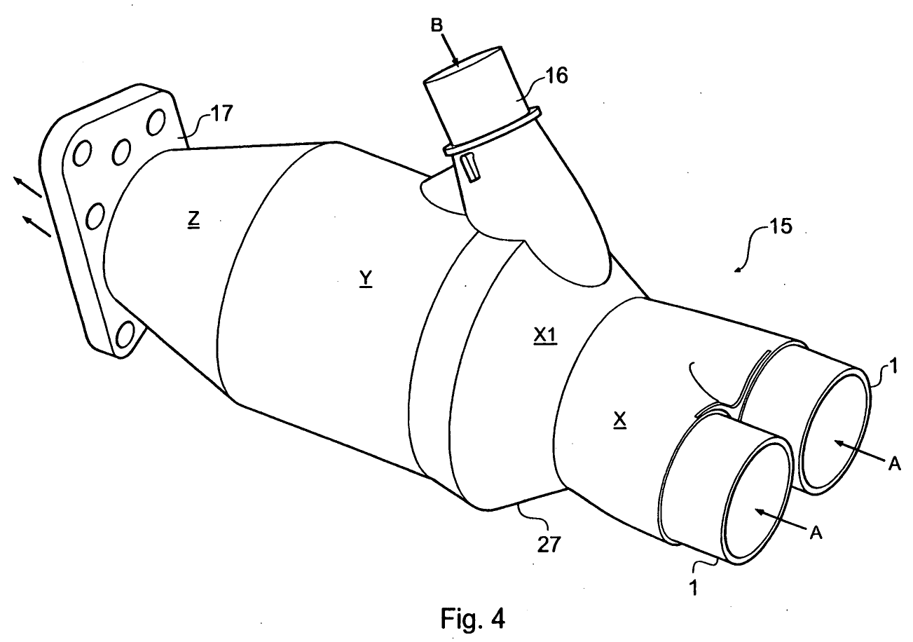

FIG. 4 is a perspective view of the one side of the chamber of FIG. 3, and

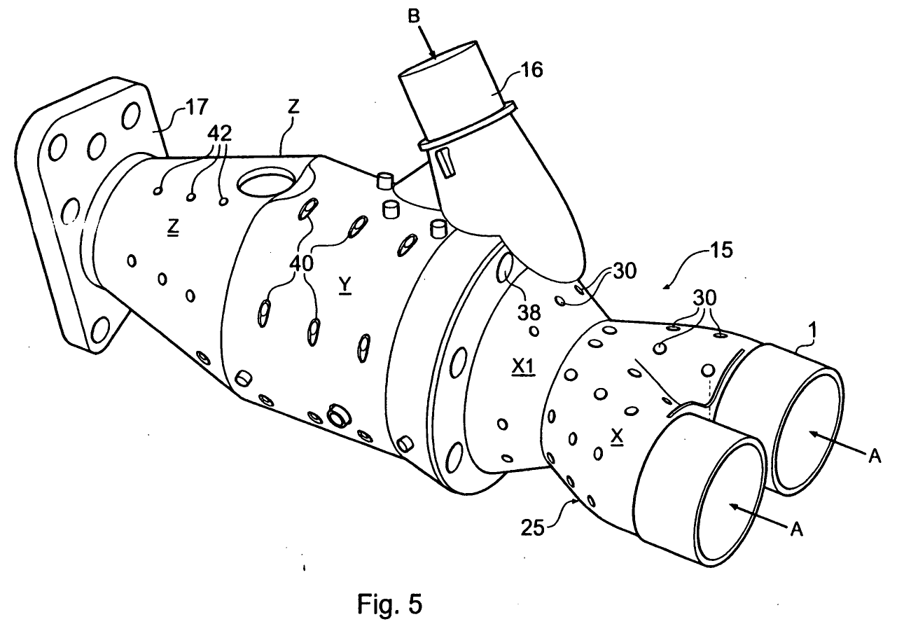

FIGS. 5-7 are further prospective views of the chamber of FIGS. 3 and 4 with parts omitted, as will be described.

Referring to the drawings and firstly to FIG. 1, there is shown an internal combustion engine 10 which may be of any convenient form, in this case a four cylinder petrol engine but the engine could also be a diesel engine or other internal combustion engine. The engine 10 has an inlet manifold 11 by which air is introduced into the combustion chambers of the engine 10 and an exhaust manifold 12 by which the products of combustion in the engine 10 are collected and discharged to an exhaust outlet 13.

A combustion chamber 15 is fed with the exhaust gases from the engine 10, and with air from an inlet 16, and discharges gas from an outlet 17 to drive a turbine 23 of a turbocharger 18. Gas is exhausted from the turbine 23 to an exhaust pipe 19 and the turbocharger 18 draws in air through an air inlet 20 for compression by a compressor 24 and discharge through a high pressure duct 21. The air in the duct 21 is directed towards the inlet manifold 11 of the engine 10 and, in addition, a controlled amount of air passes from the duct 21 to the combustion chamber inlet duct 16, control of flow of such air to the combustion chamber 15 being by a control valve 22.

In general terms, the engine shown in FIG. 1 operates in a conventional manner by air from the manifold 1I being introduced into the engine 10 with measured amounts of fuel for combustion within the combustion chambers. Exhaust gases from the engine combustion chambers passes out along the exhaust manifold 12 to the chamber 15 in which the products of combustion are mixed with air from duct 16. Combustion of combustibles from the exhaust manifold takes place within the chamber 15 thereby causing the discharge of high velocity gas from the outlet 17 to drive the turbocharger 18, operation of which causes high pressure air to be introduced to the inlet manifold 11 although part of the air is diverted by the control valve 22 to the combustion chamber 15 for efficient burning of the combustibles therein.

The internal combustion engine is run in such manner that there are combustibles in the exhaust manifold 12 and such combustibles are able to be combusted in the chamber 15. The way in which the presence of combustibles in the chamber 15 is achieved is various since it depends on the nature of the engine 10 and how much boost from the turbocharger unit is required. In one arrangement there may be an excess of fuel provided to the engine to ensure that combustibles are present in the exhaust outlet and such excess fuel may be, for example, less than 15%, preferably less than 5%.

It may also be found advantageous to introduce combustibles into the chamber 15 from another source than the exhaust manifold but this is not usually necessary. If introduction of combustible material is called for, it may be introduced directly to the inlet 13 of the combustion chamber in the form of gas or vaporised fuel and through a mixerjet (not shown).

A high rate of combustion can be achieved within the combustion chamber 15 giving the compressor 18 a constant and flexible power source and supplying high pressure combustion air to the engine 10.

Referring now, in particular, to FIG. 2, the combustion chamber is shown. The chamber 15 is of generally circular section and exhaust gases from the engine 10, including combustible products, are introduced in direction A to the inlet end of the chamber 15. Pressurised air is introduced to the chamber 15 in direction B along the air inlet duct 16.

The chamber 15 has various regions which, in the downstream direction, include an inlet region X, annulus region Y and an outlet region Z. The inlet region X increases in cross-sectional area from the inlet 13 in the downstream direction, and the annulus region Y is of generally annular shape and constant cross-section. Over the outlet region Z, the cross-section tapers inwards to the outlet 17. In the illustrated arrangement the inlet 13 is, in this case, a double pipe inlet.

The chamber 15 is double-walled to define an inner wall 25 which is the peripheral wall of the combustion region, including regions X, Y and Z. There is an outer wall 27 of the chamber 15 which is spaced from the inner wall 25 to define a space 28 which is a chamber around which air introduced to the combustion chamber passes before being admitted into the chamber in which combustion takes place.

Over the region X openings 30 are formed in the wall 25 to admit air from the chamber 28 into the region X, there being a plurality of openings 30 over both an entry area of the region X and a downstream outwardly tapered area X1 leading to the annular region Y so that air is mixed with the exhaust gases in region X.

At the boundary between the region X and the region Y is located a baffle or obstruction member 32 which is located centrally and presents a baffle surface directed towards the inlet 13. The baffle 32 is carried on one end of a central hollow elongate member 34 which extends longitudinally of the region Y and whose interior is in communication with the chamber 28 through inlet 34A to admit air from the chamber 28 along the member 34 towards the baffle 32. The elongate member 34 has a plurality of outlet openings 35 for directing such air into the region Y.

The baffle 32 is secured to the inner walls 25 of the chamber by arms 36 which are displaced at 120 degrees from one another about the centre of the baffle 32 to be secured at their outer ends to the wall 25.

It will be seen that there is defined around the member 34 in the region Y, an annular space into which gas flowing through the chamber is directed by the baffle 32. At the transition between the inlet region X and the annular region Y, there are located directional air inlet pipes 38 which are arranged to direct air into the annular space in a directional manner, as shown. Further air is directed into the annular space from directional air outlets 40 which are spaced along and about the region Y and are directed around and in the same direction, to the inner walls of the region Y.

Downstream of the annular region Y is the outlet region Z which tapers inwardly towards the outlet 17 and there is also provided a plurality of openings 42 for discharging air into the region Z, such air being provided to complete the combustion of combustibles within the chamber 15, the chamber 15 being arranged so that, as far as possible, the combustibles entering the chamber are fully burned by the time the gases leave through the outlet 17. Such gases reach a high velocity in leaving the chamber 15 to ensure that in acting on the turbine 23, the gases drive the compressor 24 at a high speed and give significant output of compressed air at the outlet 21.

During operation, gases A entering the chamber at X are mixed with air entering through outlets 30 and combustion of the combustibles takes place. The incoming gases and air are then directed outwards by the baffle 32 and are further mixed with air from the outlets 38 and there are set up burning toroidal vortices of gas and air within the annular region Y. Their formation and progression through the region Y is assisted by air being admitted from outlets 40 in the outer wall of the chamber and the outlets 35 in the elongate member 34. The vortices progress along the region Y until they reach the outlet region Z. In this region further air is mixed from the outlets 42 resulting in a high velocity stream of gases discharging through the outlet 17.

The combustion chamber 15 may, instead of relying upon combustibles being present in the exhaust gases, be provided with additional combustible material at or around the inlet 13, which material may be combustible gas, or vaporised fuel. The temperature of the exhaust gases entering the chamber 15 will be hot, for example, in the region of 1000° C., so that the combustible material self ignites entering the chamber but ignition means may be provided, if required, for example in the form of a spark plug. Additional fuel supply will not usually be necessary because the chamber is capable of promoting combustion of low concentrations of combustible material in the gas.

Referring now to FIGS. 3-7, there is shown an alternative form of combustion chamber to that in the preceding description in which the same reference numbers are used for similar parts.

Thus, the chamber 15 is put in communication with exhaust gases from the engine through inlet 1 in a direction A, the inlet again being of the form of a twin pipe inlet but other inlets can be utilised. The inlet 1 brings exhaust gas carrying combustible material into the chamber, initially region X which is surrounded by an air jacket from which air is introduced through outlets 30 after passing in direction B into the inlet 16. The region X is divergent increasing the cross section of the parts of travel of the gases which are mixed with the incoming air. The air and gas mixture then passes in to a further region X1 which diverges further and has openings 30 for admitting air From the airjacket. At the downstream end of region X1 further air is admitted from air inlet pipes 38 which are directed generally tangentially of the sides of the chamber to help to generate a swirling motion of the gas-air mixture as it enters region Y, downstream of region X1.

Region Y contains an annular member 50 which is of generally tubular construction at 51 but tapers inwardly towards its downstream end. The outer wall 52 of the tubular member 50 is spaced radially outwards from the inner wall 51 to create a hollow space D into which air is directed in direction C from the air jacket into the space D within the member 50. The tubular member 50 has a leading nose portion 53 which is directed upstream and defines a path so that gas and air can be admitted axially along the inside of the member 50 and air and gas is also directed outwardly of the nose 53 to pass along the outer sides of the member 50 in the annular space between the wall 52 and the wall 25.

Air outlets 55 are provided along the inner wall 51 to admit air from the space D into the flow of gas and air which passes down the centre of the tubular member.

Air outlets 56 are also provided in the outer wall 52 of the tubular member 50 so that air from the space D passes radially outwards into the annular space defined between the wall 52 and the wall 25 in that region. Thus air is added to the gases passing through the region Y to mix with the gases entering that region. This is to promote the further combustion of combustibles within the gases. The gases passing centrally along the tubular member 50 are mixed with the gases passing through the annular areas in the region Z which is tapered inwardly towards the outlet 17. In the region Z further air may be admitted through outlets 42 from the outer air jacket and the resulting gas stream passing through the outlet 17 is of high velocity and with the products of combustion contained in the original exhaust gas supply substantially burned. The gases exhausting from the chamber 15 are at a high velocity and generate compressed gas by operation of the turbo charger arrangement, as previously described.

The passage of gas and air through the chamber 15 is arranged in such a way that full combustion is possible and the arrangement of region Y is of particular relevance. Due to the tapering nature of the member 50 in the downstream direction, and due to the arrangement of gas nozzles 38, much of the gas and introduced air passes to the sides of the tubular member down the annular region. In passing along this region, a swirling motion of the gases is induced, it is believed in annular vortices, and the products to be combusted have a better opportunity of being burned as they pass through region Y with the object that when the gases enter region Z, combustion is approaching completion. Indeed, it has been found that the use of the combustion chamber 15 can bring about a clean exhaust from the engine in which the presence of noxious products of combustion is reduced and in which combustible products are low. In some cases it may be possible to omit other devices, such as catalytic converters, used in engine exhausts for reducing noxious emissions by reason of the cleaner emissions produced.

Although in most cases, the combustion arrangement described will give rise to combustion with most engine arrangements even without an over supply of fuel to the engine, the engine may be arranged to have a fuel supply somewhat greater than that strictly required to run the engine, whereby to provide combustible material in the exhaust gases which is then passed through the chamber 15 to assist combustion therein.

It may be the case that combustible material can be added to the exhaust gases upon entry into or before entry into the combustion chamber 15, especially if the engine is a diesel engine. In this case, the combustible material may be in the form of a liquid droplet jet or other fuel injection system.

The arrangement described has been found to give a significant power gain compared with an internal combustion engine not fitted with the combustion chamber arrangement described, as well as improving the quality of the exhaust products, and in providing the power arising from the turbo charging system in a rapid manner without any significant lag in power supply.

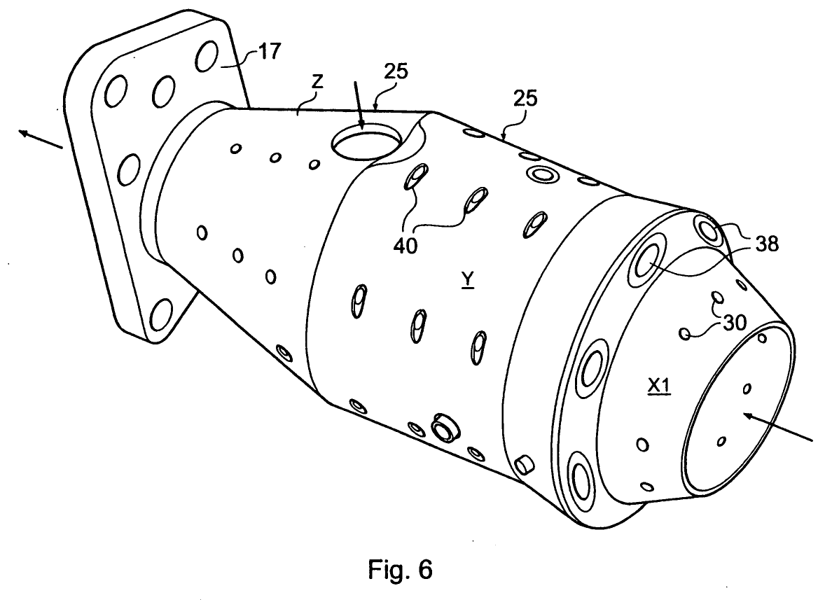

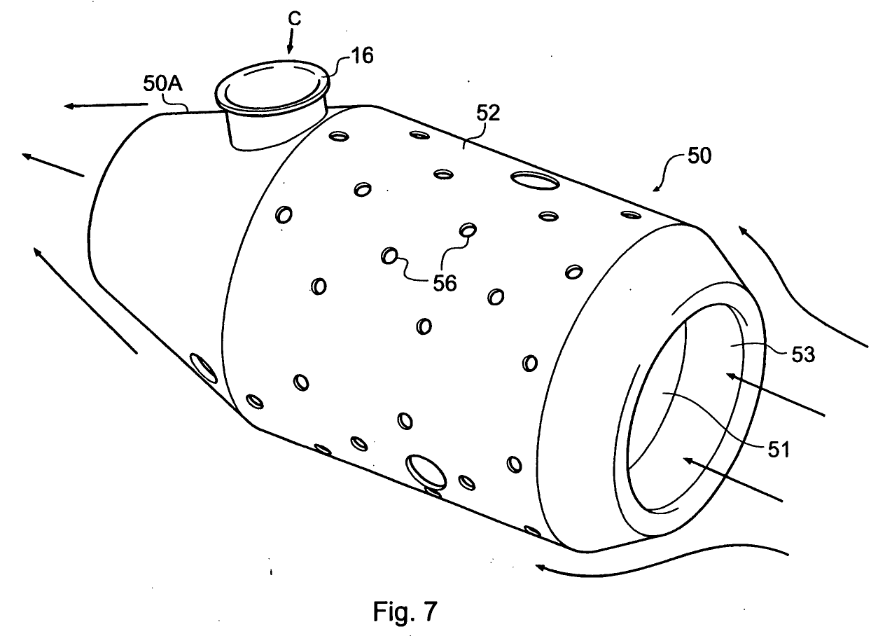

It will be appreciated that in FIGS. 4-7 there is shown pictorially, and in turn, in FIG. 4, the outer parts of the combustion chamber with the outer enclosure 27, the double inlet pipe 1, the air inlet pipe 16 and the gas discharge arrangement 17. In FIG. 5, the outer casing 27 is omitted to show the outer surface 25 with its various openings through which the air is directed from the space between the casing 27 and the inner surface 25. FIG. 6 shows a similar view but with the inlet pipes and the associated casing for the region X omitted. FIG. 7 shows the tubular member 50 having the nose 53, the inner tapering tube 51, and the outer cylindrical tube 52 in which there are formed a plurality of air outlet openings 56. Towards the discharge end the tubular member 50 is shown with a tapering portion 50A tapering inward towards the outlet 17. The tubular member 50 is supported spaced from the wall 25 of the chamber by support members 58.

Instead of there being provided an air jacket around the combustion chamber from which air is distributed to the various outlets, the air may be distributed through a series of pipes.

It will be appreciated that the turbocharger turbine may take a conventional form, but arranged to be suited to the inlet temperatures of the gases from the chamber 15 which may be at a temperature of around 750° C.

The combustion chamber of the invention may find application in a wide range of engines on which turbocharger units have conventionally been fitted and the unit may provide a means of controlling the gaseous emissions from the engine. The combustion unit or turbocharger may also find application in an arrangement in which the exhaust gases from the engine are not fed to the unit, the unit relying on the supply of air and combustible material to the inlet 13. In this arrangement the unit is still associated with a turbine/compressor to deliver a flow of air either to an internal combustion engine or equipment which requires a supply of compressed air, such as a furnace.

In a further embodiment the combustion unit may find application in controlling the emissions of an internal combustion engine without being associated with a turbine/compressor unit. In such arrangement the engine exhaust gases are supplied to the combustion unit together with a supply of air. The outlet from the unit is connected to the engine exhaust system. This may ensure more efficient operation of a catalytic converter in the exhaust system, giving rapid light-off without electric heating.

1. A combustion unit for an internal combustion engine, the unit comprising a combustion chamber having an inlet for admitting exhaust gases from the internal combustion engine, an air inlet for admitting air into the chamber, and an outlet in communication with a turbocharger having an impeller, whereby to cause gases from the chamber to drive the impeller, operation of the impeller being arranged to drive a compressor for generating a flow of air to the internal combustion engine; the chamber being arranged to cause combustion within the chamber of combustible products in the engine exhaust gas, wherein the chamber is generally of circular cross section and is arranged to have an exhaust gas inlet region which increases in cross-section in the downstream direction and into which air is introduced, a central region downstream of the inlet region in which an annular air flow is induced, and an outlet region from which the gases of combustion are discharged from the chamber outlet to drive the impeller.

2. A combustion unit according to claim 1, comprising a plurality of peripheral air inlets through which air is charged into the chamber at the outer periphery thereof and along the length of the chamber.

3. A combustion unit according to claim 1 wherein the chamber reduces in cross-section over the outlet region.

4. A combustion unit according to claim 1, wherein the combustion chamber is formed with an outer annular air chamber into which air from the turbo charger is introduced and from which the air is arranged to pass into the combustion chamber from a plurality of inlets.

5. A combustion unit according to claim 1 wherein there is provided over the central region, an annular region, and means for inducing a flow of gases outwardly in an annular flow, into said annular region.

6. A combustion unit according to claim 4, wherein the flow of air into the central region is arranged to assist the gases passing along the chamber to enter the annular region, the air inlets being directed generally tangentially to the walls of the chamber.

7. A combustion unit according to claim 5, wherein air is introduced into the chamber at the radially inner sides of the annular region in the outwards direction.

8. A combustion unit according to claim 4 wherein at the central region is provided a tubular member around which is arranged the annular region, the internal dimension of the tubular member diminishing in the downstream direction and the member defining a passage out of which air is directed into the annular region, the tubular member defining means for inducing a flow of gases into the annular region.

9. A combustion unit according to claim 1 wherein the chamber cross-section diminishes towards the outlet and air is introduced into the outlet region to complete the combustion process.

10. An internal combustion engine having an air inlet for introducing compressed combustion air into the engine, an exhaust gas outlet from the engine, a compressor for generating said compressed air flow to the engine, a compressor drive for driving the compressor, and a combustion unit providing a flow of gas for operating the compressor drive, the combustion unit having an exhaust gas inlet communicating with the exhaust gas outlet of the engine, and air inlet means for admitting air to the unit from the compressor, whereby the exhaust gas, having combustible material therein, and the air are caused to mix and combust within the unit, a gas outlet from the unit communicating with the compressor drive whereby the flow of gases from the gas outlet is arranged to drive the compressor.

11. (canceled)

12. A method of operating an internal combustion engine having a turbocharger, wherein the flow of compressed air from the turbocharger is directed into the engine, fuel is directed into the engine, exhaust gases from operating the engine are directed into a combustion unit in which combustion of combustible products in the exhaust gases is induced, and such combustion generates a flow of gas which is directed to the turbo charger which has an impeller and a compressor, the turbo charger generating a flow of pressurised air of which part is directed to the engine and part to the turbocharger.

13. A method according to claim 12, wherein the fuel supply to the engine is controlled so that more fuel reaches the engine than is required to run the engine, whereby to increase the combustible material in the exhaust from the engine.

14. A method according to claim 12, wherein up to 8% more fuel is supplied to the engine.

15. A method according to claim 12, wherein fuel is introduced into the exhaust gases supplied to the combustion chamber to assist combustion in the combustion unit.

16. (canceled)

17. A method according to claim 12, wherein the engine is a diesel engine, a four stroke or a two stroke petrol engine.

18. A method according to claim 12, wherein the internal combustion engine is in accordance with claim 10.

19. A combustion unit comprising a combustion chamber having an inlet for admitting gases containing combustible material, an air inlet for admitting air into the chamber, and an outlet in communication with a turbocharger having an impeller, whereby to cause gases from the chamber to drive the impeller, operation of the impeller being arranged to drive a compressor for generating a flow of air; the chamber being arranged to cause combustion within the chamber of the combustible material, wherein the chamber is generally of circular cross section and is arranged to have a gas inlet region which increases in cross-section in the downstream direction and into which air is introduced, a central region-downstream of the inlet region in which an annular air flow is induced, and an outlet region from which the gases of combustion are discharged from the chamber outlet to drive the impeller.

20. (canceled)

21. A combustion unit for an internal combustion engine, the unit comprising a combustion chamber having an inlet for admitting exhaust gases from the internal combustion engine, an air inlet for admitting air into the chamber, and an outlet; the chamber being arranged to cause combustion within the chamber of combustible products in the engine exhaust gas, wherein the chamber is generally of circular cross section and is arranged to have an exhaust gas inlet region which increases in cross-section in the downstream direction and into which air is introduced, a central region downstream of the inlet region in which an annular air flow is induced, and an outlet region from which the gases of combustion are discharged from the chamber outlet.

22. (canceled)

23. A combustion unit comprising a combustion chamber having an inlet for admitting gases containing combustible material, an air inlet for admitting air into the chamber, and an outlet; the chamber being arranged to cause combustion of the combustible material within the chamber, wherein the chamber is generally of circular cross section and is arranged to have a gas inlet region which increases in cross-section in the downstream direction and into which air is introduced, a central region downstream of the inlet region in which an annular air flow is induced, and an outlet region from which the gases of combustion are discharged from the chamber outlet.

24. (canceled)
